(19) United States
(12) Patent Application Publication
(10) Pub. No.: US 2017/0129343 A1
(43) Pub. Date: May 11, 2017

(54) Automotive bus train generator

(71) Applicant: Mislim Pesjaka, Brooklyn, NY (US)

(72) Inventor: Mislim Pesjaka, Brooklyn, NY (US)

(21) Appl. No.: 14/756,998

(22) Filed: Nov. 9, 2015

(51) Int. Cl. B60L 11/12; F16H 1/10; B60L 11/18

(52) U.S. Cl. CPC B60L 11/123; B60L 11/1812; F16H 1/10; Y10S 903/951; Y10S 903/907

(57) ABSTRACT

The present Invention provides a device that is capable of charging an electric battery as the vehicle Is driven, thereby extending the mileage of an electric or hybrid vehicle. The device includes a gear assembly that Is built directly into the car rim. The assembly of gears are Installed to rotate with the rotation of the rim, whereby one smaller gear is further connected to a generator, which then provides electricity to the battery with the movement of the gear.

### BACKGROUND

With the constantly changing prices of fuel, people are beginning to transition into relying on electric and hybrid vehicles. However, because the technology of these vehicles Is fairly new, the distance of travel before the battery runs out is not long enough to make It a suitable option. Further, many vehicles function inefficiently. Therefore, there Is a need for a device that can provide additional power to the vehicle in order to further usage thereof.

Devices are known that relate to motor vehicles that are driven by a turbine engine. Some devices provide electric powered vehicles having a wheel turbine and an electric motor, wherein the motor Is disposed between the wheat turbine and each rear wheel. Other devices provide two-wheeled or a four-wheeled driven gas turbine vehicles. These devices, however, do not provide a turbine that is driven by rear wheels, and a gear that is connected only to the rear wheel rims.

### BRIEF DESCRIPTION OF FIGURES

FIG. 1 displays a view of the rear wheels, gear assembly, and generators.

FIG. 2 displays a close-up view of the gear assembly connected to a rear wheel.

FIG. 3 displays a view of how the rear wheel and gear assembly turn in conjunction with the generator.

FIG. 4 displays an overhead view of how energy is provided to the battery.

FIG. 5 displays a view of the connection between the rear wheel, gear assembly, generator, and battery.

### DESCRIPTION OF INVENTION

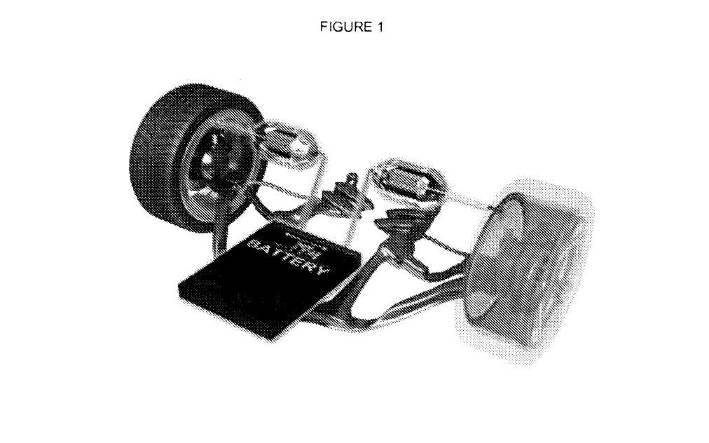

Referring now to FIG. 1, there is displayed a view of a view of the rear wheels, rear assembly, and generators. The present invention provides a means for recharging the battery of a hybrid or electric vehicle, thereby extending the vehicle's overall mileage between stationary recharging. The present invention includes a gear assembly and a turbine system connected to the rear wheels of the vehicle. In use, the gear assembly is connected to the rear wheels, and the rotation of the wheels provides a charging energy to a battery.

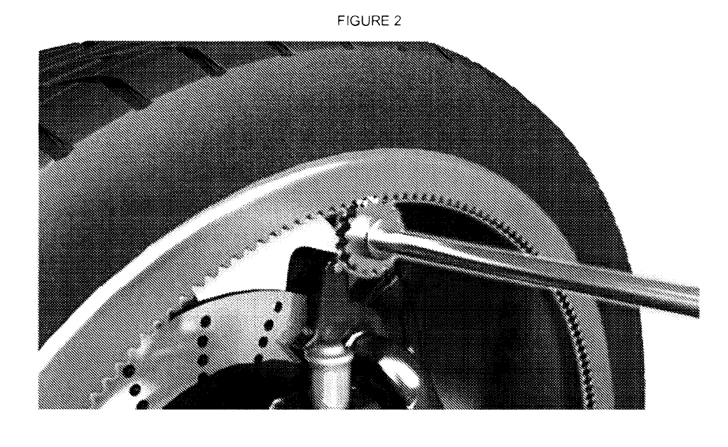

Referring now to FIG. 2, there is displayed a close-up view of the gear assembly connected to a rear wheel. The gear assembly is operatively connected to the rear wheels of the vehicle. The gear assembly includes a small gear connected to the rear wheel, which includes a plurality of notches around the rim of the rear wheel. As the wheel is rotated, the gear, which is in contact with the notches, rotates as well. The rotation of the gear, in turn, provides for the rotation of the turbine system in order to provide power to a generator.

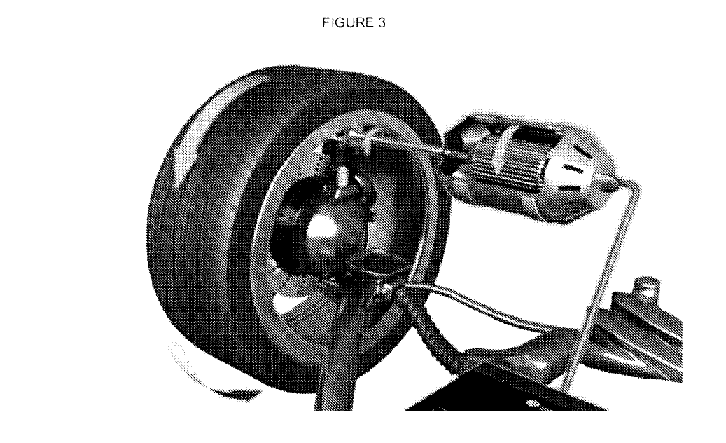

Referring now to FIG. 3, there is displayed a view of how the rear wheel and gear assembly turn in conjunction with the generator. The present invention includes a pair of gear assemblies, whereby one larger gear assembly is positioned directly inside the rim of the rear wheels and a smaller, fixed gear system is connected to a generator in the upper portion of the fixed gear. As the wheel rotates it may cause the smaller gear to turn, which in turn powers the generator that provides electricity to a battery that can be utilized for powering the electric or hybrid vehicle.

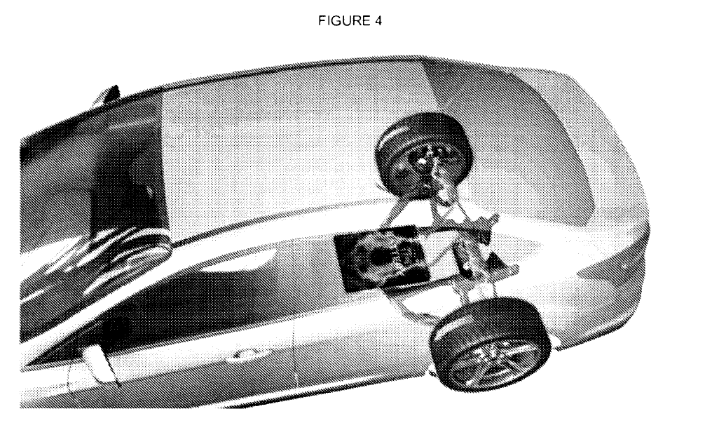

Referring now to FIG. 4, there is displayed an overhead view of how energy is provided to the battery. The present invention provides a means for harnessing energy from the rotation of the vehicle wheel and utilizing that energy for charging the battery of an electric or hybrid vehicle. The device includes a gear system connected to the notched rear wheel of a car, which causes the rotation of the gears that in turn provide energy to a generator. The generator then provides electrical energy to the battery of the vehicle, thereby extending the mileage that the vehicle can travel before recharging sessions.

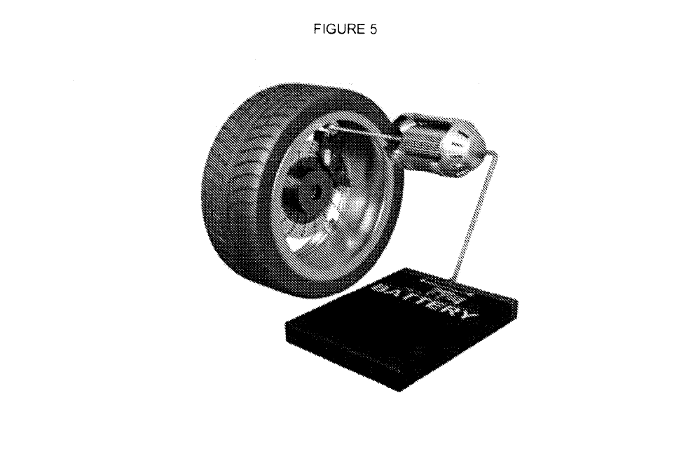

Referring now to FIG. 5, there is displayed a view of the connection between the rear wheel, gear assembly, generator, and battery. The rotation of the wheel provides movement of the turbine system, which then supplies energy to the battery from the generator. Each of the rear wheels can be utilized and both of the wheels can include their own generators, however, both generators can be utilized to power a singular battery. Further, the gear system in connection to the rear wheels can be larger than the width of the notches on the rear wheel, thereby allowing for movements of the wheel during driving without allowing for the gear to slip off the wheel. In this way, the present invention provides a device capable of charging an electric battery as the vehicle is driven, thereby extending the mileage of an electric or hybrid vehicle.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

The present invention provides a mean for a recharging the battery of a hybrid and electrical cars, hybrid and electrical buses, and electrical trains thereby extending the intended vehicles overall mileage. The present invention includes a gear assembly and generator system connected to the rear wheels of the intended vehicle. In use, the gear assembly is connected to the rear wheels, and the rotation of the wheels provides a charging energy to the battery. The gear assembly is operatively connected to the rear wheels of the intended vehicle. The gear assembly includes a small gear connected to the rear wheels, which includes a plurality of notches around the rims of the cars, buses and all the wheel of the train. As the wheel is rotated, the gear, which is in contact with the notches that rotate as well. The rotation of the gear on the wheel, in turn, provides for the generator to turn causing the generator to produce electric energy, which then powers the intended vehicle.

1. (canceled)

2. An apparatus for charging a battery of a vehicle that is at in least part electrically powered by a battery system, comprising a gear assembly operatively connected to a wheel of the vehicle; and a generator driven by the gear assembly, an electric output of the generator being connected to the battery system for battery recharging.

3. The apparatus of claim 2 wherein the gear assembly comprises a first gear, a plurality of notches arranged about a rim of the wheel and sized to mesh with the first gear, the first gear mounted to operatively engage with the notches.

4. The apparatus of claim 3 further comprising a second gear assembly operatively connected of a further wheel of the vehicle, the second gear assembly driving a second generator connected to the battery system.

5. The apparatus of claim 4 wherein the vehicle is an automobile and the wheel and further wheel are rear wheels.
